(19) United States
(12) Patent Application Publication
(10) Pub. No.: US 2013/0009815 A1
(43) Pub. Date: Jan. 10, 2013

(54) POSITIONING SYSTEM USING PSEUDOLITES OPERATING IN ASSISTED MODE

(75) Inventor: Michel Monnerat, Saint Jean (FR)

(73) Assignee: THALES, Neuilly Sur Seine (FR)

(21) Appl. No.: 13/634,542

(22) PCT Filed: Feb. 3, 2011
(86) PCT No.: PCT/EP2011/051542

§ 371 Date: Sep. 12, 2012

(30) Foreign Application Priority Data
Mar. 12, 2010 (FR) 1000998

(51) Int. Cl. G01S 19/11

(52) U.S. Cl. 342/357.48

(57) ABSTRACT

A system for positioning an object provided with a receiver, which includes a set of pseudolites transmitting positioning signals and distributed in a constrained area, assistance means capable of communicating with said receiver and calculating a position of the object, and a server capable of dynamically configuring the set of pseudolites, the pseudolites each further having a spreading code corresponding to that of a satellite belonging to a satellite constellation in a satellite navigation system, the dynamic configuration of the pseudolites by the server is such that the spreading codes of said pseudolites correspond to spreading codes of satellites of the satellite constellation not visible to the receiver of the object, wherein the assistance means is configured to communicate to said receiver a list of spreading codes meant to be those of the satellites visible to said receiver but actually corresponds to the spreading codes of the set of pseudolites so as to deceive the receiver that can acquire the positioning signals transmitted by the pseudolites and communicate with the assistance means so that the assistance means calculates the position of the object.

The present invention concerns a system enabling an object equipped with an appropriate receiver to determine its position within a constrained area.

The positioning system of the present invention is more particularly based on the use of pseudolites.

As is known in the art, pseudolites (pseudo-satellites) are devices operating in accordance with the same principles as satellites belonging to constellations of satellites used in satellite navigation systems, known as Global Navigation Satellite Systems (GNSS), such as the Global Positioning System (GPS) or the Galileo system. Unlike satellites, pseudolites are deployed on the ground. They may typically be distributed in a building and are generally distributed in so-called constrained areas.

The general principle of pseudolite positioning systems is based on the fact that said pseudolites transmit positioning signals the format of which is identical or similar to that of messages transmitted by satellites of a satellite navigation system. For good compatibility with existing systems, notably the receivers, each pseudolite is generally allocated an identifier corresponding to that of a satellite. In the context of constellations of satellites, these identifiers are called spreading codes, as the person skilled in the art knows. The range of the signals transmitted by pseudolites is variable; it depends on their power and on their use. Objects equipped with appropriate receivers can acquire these positioning signals. As in a classic satellite navigation system, calculation of pseudodistances between said object and the pseudolites from which it has acquired the positioning signals, followed by a triangulation calculation, enable the position of the object to be determined. The principle of positioning by triangulation is known in itself: it is a question of determining the position of a receiver as being at the intersection of spheres with centers at the transmitters and the distance between receiver and transmitters as radius. The calculations may be effected onboard the object itself or remotely by a server.

Pseudolite positioning systems are generally deployed in so-called “constrained” areas. These are typically buildings in which positioning signals transmitted by satellites in Earth orbit cannot be acquired because of the masking effect of walls, ceilings, etc. They may be areas not covered by the satellite navigation system concerned. Generally speaking, a constrained area will be defined as an area in which positioning signals transmitted by satellites cannot be acquired correctly. In contrast, the expression “open area” may be used in respect of areas in which positioning signals transmitted by satellites may be acquired by an appropriate receiver. Moreover satellites from which a receiver can theoretically receive positioning signals, because of the suitable relative position between said satellites and said receiver, are referred to as “visible” to the receiver, while the other satellites of the constellation are referred to as “non-visible”. These terms “visible” and “non-visible” may be used in the case of pseudolites.

The definitions given above of the terms “constrained area”, “open area”, “visible satellite” and “non-visible satellite” are valid throughout the remainder of the description and the claims.

It is also known in the art that satellite positioning systems are often complemented by an assistance system. This technology is well known to the person skilled in the art as Assisted-GNSS. These assistance systems are generally based on a server called the assistance server the role of which is to send information to the receiver concerning the constellation of satellites, such as the position of the visible satellites, and other assistance facilitating processing of the positioning signals. A pseudolite positioning system may also have an assistance server of this kind. In so-called “assisted” mode, this assistance server generally calculates the position of the receiver based on calculations of pseudodistances that the latter supplies it with. This mode of operation is also well known to the person skilled in the art as MS-Assisted (Mobile Station Assisted) or UE-Assisted (User Equipment Assisted) Mode.

The invention is used in such an assisted mode of operation.

The prior art discloses various technologies. Firstly, by way of alternatives to pseudolite positioning, there are known WiFi positioning techniques, but this solution is acceptable only in static environments, and necessitates the deployment of dedicated equipment for location in constrained areas and relatively tedious calibration phases. Still in connection with alternatives, there are also used positioning techniques founded on the GSM or UMTS standards, for example, enabling a mobile telephone to be located in the areas covered; however, the accuracy achieved is of the order of a few tens of meters, which is not satisfactory.

Finally, known pseudolite positioning systems have a number of drawbacks. In particular, they make no provision for moving from a constrained area to an open area and vice versa in a continuous and autonomous manner. Moreover, they generally do not provide for a cold start without a knowledge of the initial position of the receiver. The known systems generally involve the use of receivers specifically designed to operate in constrained areas and to acquire positioning signals transmitted by pseudolites.

In other cases they necessitate intervention on the receiver for the latter to begin to acquire signals transmitted by pseudolites, which are identified by specific spreading codes, potentially unknown to the receivers the vocation whereof is to use satellites and that consequently know only the spreading codes of said satellites. In any event, the modes of operation in constrained areas and in open areas are generally not compatible, in the sense that they may not be active simultaneously.

Moreover, an important constraint to be taken into consideration lies in the fact that the spreading codes of satellites belonging to constellations of satellites are reserved for said satellites. It is not possible to use other codes without having to design dedicated receivers, because the receivers commercially available are designed to acquire positioning signals coming from the satellites.

An object of the invention is to alleviate these drawbacks by proposing a pseudolite positioning system adapted to operate with standard receivers able to acquire transparently, from the point of view of the receiver, positioning signals transmitted by pseudolites as if they were positioning signals transmitted by satellites belonging to a satellite constellation of a satellite navigation system.

The general principle of the invention therefore consists in deceiving the receiver so that when it acquires positioning signals transmitted by pseudolites provided in the constrained area in which it is located, said receiver has the impression of acquiring normally signals transmitted by visible satellites. This is made possible by the system defined by claim 1.

Accordingly, the invention consists in a system for positioning an object provided with a receiver, which includes a set of pseudolites transmitting positioning signals and distributed in a constrained area and assistance means capable of communicating with said receiver and calculating the position of the object, and a server capable of dynamically configuring the set of pseudolites, said pseudolites each further having a spreading code corresponding to that of a satellite belonging to a satellite constellation in a satellite navigation system, the dynamic configuration of the pseudolites by the server being such that the spreading codes of said pseudolites correspond to spreading codes of satellites of the satellite constellation not visible to the receiver of the object, wherein assistance means communicate to said receiver a list of spreading codes meant to be those of the satellites visible to said receiver but actually corresponding to the spreading codes of the set of pseudolites so as to deceive the receiver that can acquire the positioning signals transmitted by the pseudolites and communicate with the assistance means so that the latter calculates the position of the object.

In one embodiment of the invention the position of each pseudolite of the set of pseudolites in the constrained area being known to the assistance means, the position of the object is calculated by triangulation from the known positions of the pseudolites and pseudodistance measurements carried out by the receiver.

In another embodiment the receiver may have access to the ephemerides of the satellite constellation, the assistance means also communicating to said receiver an erroneous current time corresponding to the current time shifted by an offset so that the receiver consulting the ephemerides determines that the spreading codes of the pseudolites correspond to spreading codes of satellites of the satellite constellation deemed to be visible to said receiver.

The pseudolites advantageously transmit at the current time positioning signals identical to the positioning signals that the satellites of the satellite constellation would transmit of which they borrow the spreading code at the erroneous current time.

The assistance means advantageously also communicate to said receiver a non-integrity flag for the set of spreading codes of satellites of the satellite constellation not allocated to pseudolites.

The server advantageously implements the assistance means by means of appropriate programming.

Other features and advantages of the invention will become apparent in the light of the following description given with reference to the appended drawings in which:

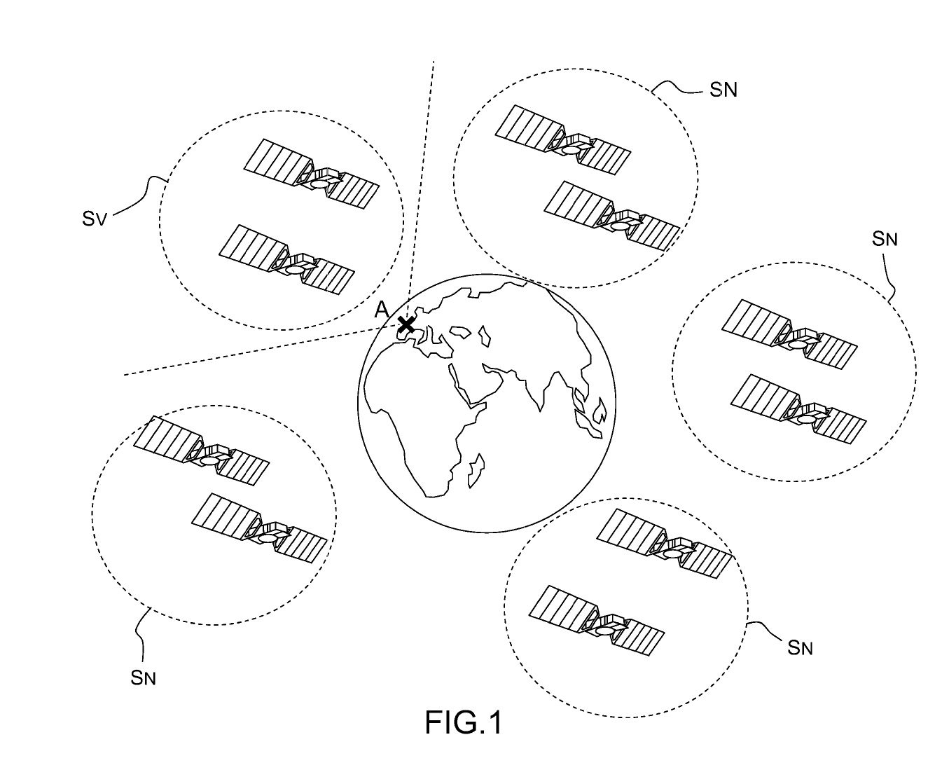

FIG. 1 is a diagram of one example of the disposition around the Earth of satellites of a satellite navigation system;

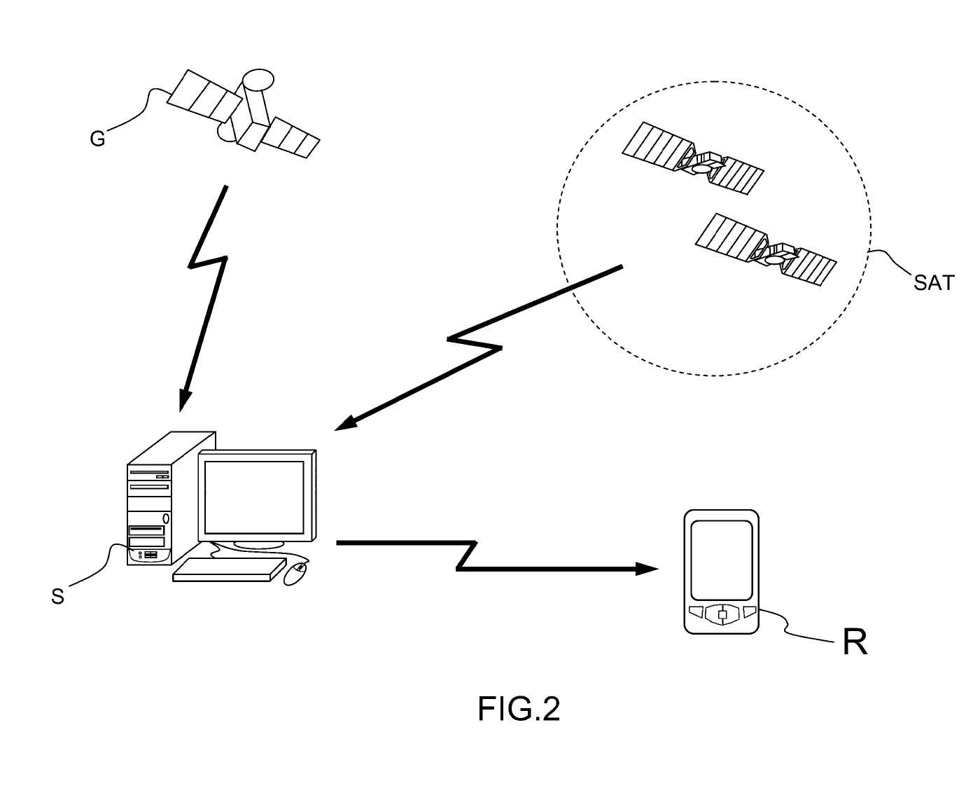

FIG. 2 is a diagrammatic representation of the operating principle of a satellite navigation system in assisted mode.

The figure illustrates the definition given above, and well known to the person skilled in the art, of the terms “visible satellite” and “non-visible satellite”. As FIG. 1 shows, at a given time, from the point A situated on the surface of the Earth, only the satellites SV are visible, whereas the satellites SN are not visible. Because of this, only positioning signals transmitted by the visible satellites SV could be acquired by a receiver placed at the point A.

On the other hand, as mentioned above, the pseudolite positioning system of the invention uses an assistance server controlling all of the pseudolites equipping the constrained area concerned, in which the object to be positioned is found. This assistance server is notably programmed to perform the function of dynamic allocation of a spreading code to each of the pseudolites of the constrained area.

FIG. 2 represents the general principle of a so-called “assisted” mode of operation of a satellite navigation system (Assisted-GNSS, see above). In the FIG. 2 example, the assistance server S collects information transmitted by the satellites of the satellite constellation SAT belonging to a satellite navigation system and, optionally, information transmitted by other satellites, for example geostationary satellites G belonging to a data collection system. The assistance server S exploits this information to be in a position to supply a receiver R on demand with assistance data such as:
location information,
time references, such as the “GPS time”,
navigation information, such as the ephemerides and the corrections applicable to the clocks of the satellites SAT,
up to date corrections of the models relating to the ionosphere,
correction information for effecting differential navigation,
information on the integrity of the positioning signals received as a function of the transmitter satellite,
the almanachs of the satellite constellation SAT,
the list of the identifiers, generally the spreading codes, of the visible satellites of the satellite constellation SAT as a function of the area in which the receiver R is located,
the ephemerides of the satellite constellation SAT extended for a period of several days,
etc.

The principle of the invention consists in deceiving the receiver R of the object to be positioned by appropriate programming of the assistance server S.

Firstly, the assistance server S is programmed to assign dynamically to the pseudolites spreading codes which are those of the satellites not visible from the constrained area concerned. This is possible because the assistance server S knows the position of all of the satellites of the satellite constellation SAT concerned and the corresponding ephemerides. This point is crucial to avoiding any risk of interference, on the one hand vis-à-vis users outside the constrained area, and on the other hand vis-à-vis real satellites in areas in which positioning signals transmitted by satellites may be received even in a constrained area: for example, inside a building, there may be areas located near windows. It might not be possible to distinguish positioning signals transmitted by pseudolites from those transmitted by satellites.

According to the invention, the assistance server S supplies to the receiver R assistance data modified with a view to deceiving said receiver R.

This modified data supplied by the assistance server comprises:
A list of the spreading codes of the pseudolites visible from the constrained area in which the receiver R is located, corresponding to spreading codes of non-visible satellites SN.
Preferably a time reference deemed to correspond to the current time, called the

Time Of Week, but equal to the current time offset so that, if the receiver R has stored in its internal memory the almanachs of the constellations of satellites with the object of determining autonomously the list of visible satellites, said receiver detects no inconsistency between the list of visible satellites—corresponding in reality to the list of visible pseudolites supplied by the assistance server S—and the list of visible satellites that it would be able to determine for itself. The offset applied must consequently be chosen appropriately, so that the spreading codes of the pseudolites correspond to spreading codes of satellites deemed to be visible at the modified current time, equal to the current time shifted by said offset.
Optionally, a non-integrity flag for satellites deemed not to be visible at the modified current time but in practice liable to be visible at the real current time. A non-integrity flag is interpreted by a receiver R as signifying that the signals transmitted by the satellites to which the non-integrity flag relates are erroneous and must not be acted upon. Such a non-integrity flag concerning all of the satellites the spreading code whereof has not been assigned to a pseudolite may thus be broadcast to the receiver R. In this way, the receiver R will not seek to acquire these satellites and will therefore save energy; moreover, there will be no risk of conflict in the case of calculating positions from positioning signals coming both from pseudolites and from satellites SV.

Moreover, in the assisted mode used in the context of the invention, the pseudodistances are preferably calculated and the position of the receiver is preferably determined by the assistance server or any appropriate computer. Because of this, the receiver R does not need to manipulate the pseudolite position information.

The assistance server S broadcasting modified assistance data may be constituted of separate means comprising assistance means calculating the modified assistance data to be broadcast and a server for broadcasting said modified assistance data.

The main advantage of the invention is to propose a solution for pseudolite positioning in constrained areas that is transparent for most standard receivers able to acquire positioning signals in the context of a global satellite navigation system. No hardware modification is required and no particular software needs to be developed to implement the proposed solution, which is based on programming and on an original configuration of an assistance server enabling deception of said receivers.

1. A system for positioning an object provided with a receiver, the system comprising:
a set of pseudolites transmitting positioning signals and distributed in a constrained area;
assistance means capable of communicating with said receiver and calculating a position of the object; and
a server capable of dynamically configuring the set of pseudolites, wherein
said pseudolites each further have a spreading code corresponding to that of a satellite belonging to a satellite constellation in a satellite navigation system,
the dynamic configuration of the pseudolites by the server is such that the spreading codes of said pseudolites correspond to spreading codes of satellites of the satellite constellation not visible to the receiver of the object,
the assistance means is configured to communicate to said receiver a list of spreading codes meant to be those of the satellites visible to said receiver but actually corresponds to the spreading codes of the set of pseudolites so as to deceive the receiver that can acquire the positioning signals transmitted by the pseudolites and communicate with the assistance means so that the assistance means calculates the position of the object.

2. The system as claimed in claim 1, wherein
the position of each pseudolite of the set of pseudolites in the constrained area is known to the assistance means; and
the assistance means is configured to calculate the position of the object by triangulation from the known positions of the pseudolites and pseudodistance measurements carried out by the receiver.

3. The system as claimed in claim 1, wherein
the receiver has access to ephemerides of the satellite constellation; and
the assistance means is configured to communicate to said receiver an erroneous current time corresponding to a current time shifted by an offset so that the receiver consulting the ephemerides determines that the spreading codes of the pseudolites correspond to spreading codes of satellites of the satellite constellation deemed to be visible to said receiver.

4. The system as claimed in claim 3, wherein the pseudolites transmit at the current time positioning signals identical to the positioning signals that the satellites of the satellite constellation would transmit of which they borrow the spreading code at the erroneous current time.

5. The system as claimed in claim 1, wherein the assistance means is configured to communicate to said receiver a non-integrity flag for the set of spreading codes of satellites of the satellite constellation not allocated to pseudolites.

6. The system as claimed in claim 1, wherein the server is programmed to implement the assistance means.
